(19) United States
(12) Patent Application Publication
(10) Pub. No.: US 2016/0225188 A1
(43) Pub. Date: Aug. 4, 2016

(54) VIRTUAL-REALITY PRESENTATION VOLUME WITHIN WHICH HUMAN PARTICIPANTS FREELY MOVE WHILE EXPERIENCING A VIRTUAL ENVIRONMENT

(71) Applicant: VRstudios, Inc., Bellevue, WA (US)

(72) Inventors: Dave Edward Ruddell, Bellevue, WA (US); Jamie Kelly, Bellevue, WA (US); Mark Haverstock, Bellevue, WA (US)

(73) Assignee: VRstudios, Inc., Bellevue, WA (US)

(21) Appl. No.: 15/000,695

(22) Filed: Jan. 19, 2016

Related U.S. Application Data
(60) Provisional application No. 62/104,344, filed on Jan. 16, 2015.

(51) Int. Cl. G06T 19/00; G06F 3/01; G06T 7/00

(52) U.S. Cl. CPC G06T 19/006; G06T 7/004; G06F 3/011; G06T 2207/30208; G06T 2207/30196

(57) ABSTRACT

The current document is directed to a virtual-reality system, and methods incorporated within the virtual-reality system, that provides a scalable physical volume in which human participants can freely move and assume arbitrary body positions while receiving electronic signals that are rendered to the human participants by virtual-reality rendering appliances to immerse the human participants in a virtual environment. In a described implementation, the virtual-reality system includes multiple networked optical sensors, a computational tracking system, networked virtual-reality engines, and virtual-reality rendering appliances.

### CROSS-REFERENCE TO RELATED APPLICATION

This application claims the benefit of Provisional Application No. 62/104,344, filed Jan. 16, 2015.

### TECHNICAL FIELD

The current document is directed to methods and systems for providing virtual-reality experiences to human participants and, in particular, to a virtual-reality presentation volume that is a generally large physical spatial volume monitored by a tracking system in which human participants freely move while visual and audio data is transmitted by virtual-reality engines to rendering appliances worn by the participants that produce a virtual-reality experience for the participants.

### BACKGROUND

Virtual-reality systems and the desire to provide virtual reality experiences may be fairly described as dating back thousands of years to early live-theater performances intended to create a sensory experience that immersed viewers in a virtual environment different from their actual physical environment. To some degree, almost all art and music are intended to create a type of virtual-reality experience for viewers and listeners. As science and technology has progressed, the techniques and systems used for creating increasingly effective virtual-reality experiences progressed through panoramic murals, motion pictures, stereophonic audio systems, and other such technologies to the emergence of computer-controlled virtual-reality headsets that provide stereoscopic visual displays and stereophonic audio systems to immerse users in a dynamic and interactive virtual environment. However, despite significant expenditures of money and scientific and engineering efforts, and despite various over-ambitious promotional efforts, lifelike virtual-reality experiences remain difficult and often impractical or infeasible to create, depending on the characteristics of the virtual-reality environment intended to be provided to participants.

Virtual-reality technologies are useful in many real-world situations, including simulations of aircraft cockpits for pilot training and similar simulations for training people to perform a variety of different complex tasks, virtual-reality gaming environments, and various of entertainment applications. Designers, developers, and users of virtual-reality technologies continue to seek virtual-reality systems with sufficient capabilities to produce to useful and lifelike virtual-reality experiences for many different training, gaming, and entertainment applications.

### SUMMARY

The current document is directed to a virtual-reality system, and methods incorporated within the virtual-reality system, that provides a scalable physical volume in which human participants can freely move and assume arbitrary body positions while receiving electronic signals that are rendered to the human participants by virtual-reality rendering appliances to immerse the human participants in a virtual environment. In the current document, the virtual-reality system, including the scalable physical volume, is referred to as a “virtual-reality presentation volume.”

In a described implementation, the virtual-reality system includes multiple networked optical sensors distributed about the scalable physical volume that continuously track the positions of human participants and other objects within the scalable physical volume, a computational tracking system that receives optical-sensor output and uses the optical-sensor output to compute positions of markers and orientations of multiple-marker patterns attached to, or associated with, participants and other objects within the scalable physical volume that together comprise tracking data. The tracking data is output by the computational tracking system to networked virtual-reality engines, each comprising a computational platform that executes a virtual-reality application. Each virtual-reality engine uses the tracking information provided by the computational tracking system to generate visual, audio, and, in certain implementations, additional types of data that are transmitted, by wireless communications, to a virtual-reality rendering appliance worn by a participant that renders the data to create a virtual-reality environment for the participant.

### BRIEF DESCRIPTION OF THE DRAWINGS

FIG. 1 illustrates one implementation of the virtual-reality presentation volume to which the current document is directed.

FIGS. 2-3 illustrate the interconnections and data paths between the high-level components and subsystems of the virtual-reality presentation volume.

FIG. 4 shows an exploded view of a headset that represents one implementation of a virtual-reality rendering appliance.

FIG. 5 provides a wiring diagram for the headset implementation of the virtual-reality rendering appliance illustrated in FIG. 4.

FIG. 6 uses a block-diagram representation to illustrate the virtual-reality library that continuously receives tracking data from the motion-capture server and applies position and orientation information to virtual components of the virtual-reality environment generated by the virtual reality application within a virtual-reality engine.

FIG. 7 provides a control-flow diagram that describes tracking-data-frame processing by the data-collection and data-processing layers of the virtual-reality library.

FIG. 8 provides a control-flow diagram for motion prediction by the frame processor (614 in FIG. 6).

### DETAILED DESCRIPTION

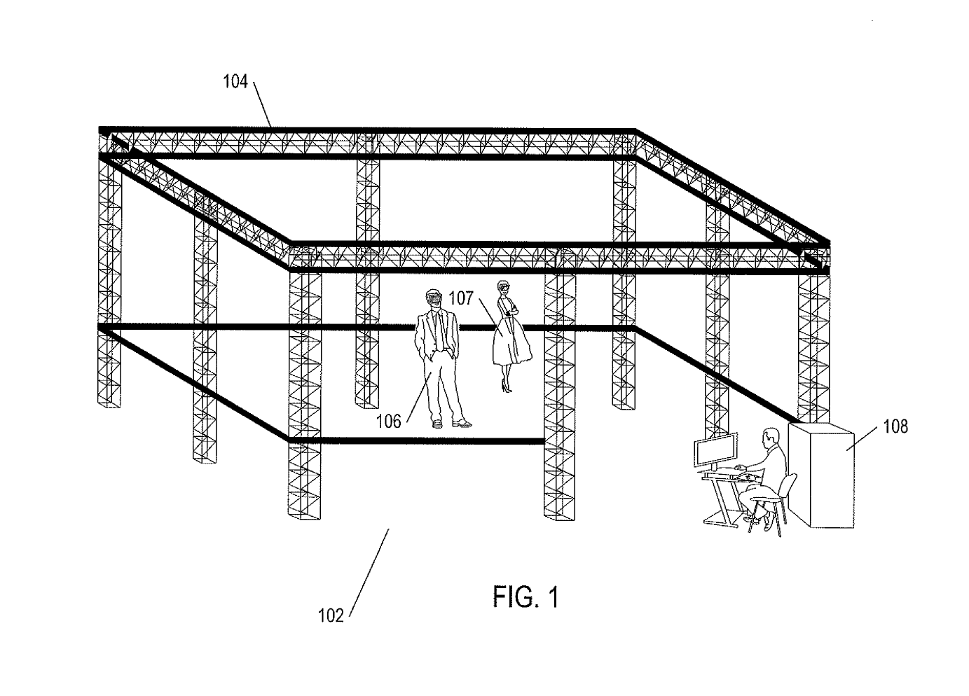

FIG. 1 illustrates one implementation of the virtual-reality presentation environment to which the current document is directed. In this implementation, the virtual-reality presentation volume is the physical spatial volume bounded by a floor 102 and five rectangular planes defined by a structural framework 104. Within the virtual-reality presentation volume, human participants 106 and 107 may freely move and position themselves in arbitrary body positions. Infrared cameras, mounted within the structural framework and/or on the walls and ceilings of an enclosing room or structure continuously image the virtual-reality presentation volume from different positions and angles. The images captured by the optical cameras, in one implementation infrared motion-capture cameras, are continuously transmitted to a computational tracking system 108 that continuously processes the images in order to determine the positions of physical labels, or markers, and the orientations of certain previously specified multi-marker patterns attached to the human participants and other objects within the virtual-reality presentation volume. The computational tracking system continuously produces tracking data that includes information about the positions of each marker and the orientations of certain multi-marker patterns. This tracking data is then broadcast, through a network, to a number of virtual-reality engines. In the implementation shown in FIG. 1, these virtual-reality engines are based on personal computers or mobile devices interconnected by a network to the computational tracking system and are contained within the large cabinet that additionally contains the computational tracking system 108. The virtual-reality engines each comprises an underlying computational device and one or more virtual-reality applications. Each virtual-reality engine communicates with a different virtual-reality rendering appliance worn by a human participant. In the described implementation, wireless communications is used to interconnect virtual engines with virtual-reality rendering appliances to allow unencumbered movement of human participants within the virtual-reality presentation volume. The virtual-reality engines continuously receive a stream of tracking data from the computational tracking system and use the tracking data to infer the positions, orientations, and translational and rotational velocities of human participants and other objects and to generate, based on this information, virtual-reality-environment data that, when transmitted to, and rendered by, a virtual-reality rendering appliance, provides position-and-orientation-aware input to the biological sensors of human participants so that they experience a virtual-reality environment within which they can move and orient themselves while perceiving life-like reflections of their movements in the virtual-reality environment. The life-like reflections include natural changes in the perspective, size, and illumination of objects and surfaces in the virtual-reality environment consistent with the physical movements of the participants.

The virtual-reality presentation volume may be scaled to fit a variety of different physical spaces. Three-dimensional virtual forms may be generated for human participants and other physical objects within the virtual-reality presentation volume to allow human participants to perceive one another and other physical objects and to interact with one another and other physical objects while fully immersed in a virtual-reality environment. The virtual-reality environment may also include a variety of virtual lines, planes, and other boundaries in order to virtually confine human participants within all or a portion of the virtual-reality presentation volume. These virtual boundaries can be used, for example, to prevent participants, while fully immersed in a virtual-reality environment, from walking or running out of the virtual-reality presentation volume and colliding with walls and objects external to the virtual-reality volume.

The virtual-reality environments produced by the virtual-reality presentation volume through the virtual-reality rendering appliances to human participants may vary widely with various different applications. For example, one application is to provide virtual building, structure, and room environments to allow clients of an architectural or building firm to walk about and through a building, structure, or room that has not yet been actually constructed in order to experience the space as the clients would in the actual building, structure, or room. The virtual-reality presentation volume can generate a highly realistic and dimensionally accurate virtual-reality environment from construction plans and various information collected from, and generated to describe, the total environment of the planned building or room. The client and a designer or architect may together walk through the virtual-reality environment to view the room or building as it would appear in real life, including furnishings, scenes visible through windows and doorways, art work, lighting, and every other visual and audio features that could be perceived in an actual building or room. In certain implementations, the client may actually operate virtual appliances as well as change the environment by moving or changing objects, walls, and other components of the environment.

Another application is for virtual gaming arcades that would allow human participants to physically participate in action-type virtual-reality gaming environments. Many additional applications are easily imagined, from virtual-reality operating rooms for training surgeons to virtual-reality flight simulators for training pilots and flight engineers. In many applications, the movement of the participants may be realistically scaled to the dimensions of the virtual-reality environment in which they are immersed. However, in certain applications, different types of non-natural scalings may be employed. For example, in a city-planning virtual-reality environment, participants may be scaled up to gigantic sizes in order to view and position buildings, roadways, and other structures within a virtual city or landscape. In other applications, participants may be scaled down to molecular dimensions in order to view and manipulate complex biological molecules.

Wireless communications between the virtual-reality engines and virtual-reality rendering appliances significantly facilitates a natural and lifelike virtual-reality experience, because human participants are not encumbered by cables, wires, or other real-world impediments that they cannot see and manipulate when immersed in a virtual-reality environment. It is also important that the data-transmission bandwidths, virtual-reality-environment-data generation speeds, and the speed at which this data is rendered into biological-sensor inputs are sufficient to allow a seamless and lifelike correspondence between the perceived virtual-reality environment and body motions of the human participants. For example, when a participant rotates his or her head in order to look around a room, the virtual-reality-environment-data generation and rendering must be sufficiently fast to prevent unnatural and disorienting lags between the participants internally perceived motions and the virtual input to the participants' eyes, ears, and other biological sensors.

In many implementations, the virtual-reality rendering appliance is a virtual-reality headset that includes LED stereoscopic visual displays and stereophonic speakers for rendering audio signals. However, other types of sensory input can be generated by additional types of rendering components. For example, mechanical actuators incorporated within a body suit may provide various types of tactile and pressure inputs to a participant's peripheral nerves. As another example, various combinations of odorants may be emitted by a smell-simulation component to produce olfactory input to human participants.

To reiterate, the virtual-reality presentation volume includes a scalable, physical volume, a motion capture system, networked virtual-reality engines, and virtual-reality rendering appliances connected by wireless communications with the virtual-reality engines. In one implementation, the virtual-reality rendering appliance is a headset that includes a stereoscopic head-mounted display (“HMD”), a wireless transceiver, and an audio-playback subsystem. The motion capture system includes multiple infrared optical cameras that communicate through a network with a motion-capture server, or computational tracking system. The optical cameras are mounted in and around the scalable physical volume, creating a capture volume within which the positions of physical markers attached to participants and other objects are tracked by the motion capture system. Each camera sends a continuous stream of images to the computational tracking system. The computational tracking system then computes the (x,y,z) positions of markers and orientations of multi-marker patterns within the virtual-reality presentation volume. Predetermined multi-marker patterns allow the computational tracking system to compute both the translational (x,y,z) position and the orientation of multiple-marker-labeled participants, participants' body parts, and objects. Tracking data that includes the positions and orientations of participants and objects is continuously broadcast over a virtual-reality client network to each virtual-reality engine that has subscribed to receive the tracking data.

Each participant is associated with a dedicated virtual-reality engine which, as discussed above, comprises an underlying computational platform, such as a personal computer or mobile device, and a virtual-reality application program that executes on the underlying computational platform. The virtual-reality application program continuously receives tracking data from the motion-capture system. A virtual-reality application program includes a code library with routines that process received tracking data in order to associate position and orientation information with each entity, including participants and objects, that is tracked in the context of a virtual-reality environment presented by the virtual-reality engine to the participant associated with the virtual-reality engine. The positions and orientations of participants and other objects are used by the virtual-reality application to generate, as one example, a virtual-reality-environment rendering instance reflective of a participant's position and orientation within the virtual-reality presentation volume. As another example, in a multi-participant virtual-reality environment, each participant may view virtual-reality renderings of other participants at spatial positions and orientations within the virtual-reality environment reflective of the other participants' physical positions and orientations within the physical presentation volume. The virtual-reality engines continuously transmit, by wireless communications, generated audio, video, and other signals to one or more virtual-reality rendering appliances worn by, or otherwise associated with, the participant associated with the virtual-reality engine. In one implementation, a virtual-reality headset receives the electronic signals and demultiplexes them in order to provide component-specific data to each of various different rendering components, including a stereoscopic HMD and stereophonic audio-playback subsystem. In addition, active objects within the virtual-reality presentation volume may communicate with a participant's virtual-reality engine or, in some implementations, with a virtual-reality engine dedicated to the active object. The data exchanged between the virtual-reality rendering appliance and virtual-reality engine may include two-way communications for voice communications and other types of communications.

In one implementation, the markers, or labels, tracked by the computational tracking system are retro-reflective markers. These retro-reflective markers can be applied singly or as multiple-marker patterns to various portions of the surfaces of a participant's body, on various portions on the surfaces of the virtual-reality rendering appliances, and on other objects present in the virtual-reality presentation volume. In this implementation, the networked optical cameras are infrared motion capture cameras that readily image the retro-reflective markers. In one implementation, all of the infrared motion capture cameras communicate with a central computational tracking system via a network switch or universal serial bus (“USB”) hub. This central computational tracking system executes one or more motion-capture programs that continuously receive images from the infrared motion capture cameras, triangulate the positions of single markers, and determine the orientations of multiple-marker patterns. The computational tracking system can also compute the orientations of single markers with asymmetric forms, in certain implementations. The position and orientation data generated by the computational tracking system is broadcast using a multi-cast user data protocol (“UDP”) socket to the network to which the virtual-reality engines are connected. The virtual-reality library routines within the virtual-reality engines continuously receive the tracking data and process the tracking data to generate positions, orientations, translational and angular velocities, translational and angular accelerations, and projected positions at future time points of participants and objects within the virtual-reality presentation volume. This data is then translated and forwarded to the virtual-reality application program which uses the positions, orientations, translational and angular velocities, translational and angular accelerations, and projected positions at future time points to generate virtual-reality-environment data for transmission to the virtual-reality rendering appliance or appliances worn by, or otherwise associated with, the participant associated with the virtual-reality engine. The virtual-reality-environment data, including audio and video data, is sent from the high-definition multi-media interface (“HDMI”) port of the computational platform of the virtual-reality engine to a wireless video transmitter. The wireless video transmitter then directs the virtual-reality-environment data to a particular virtual-reality rendering appliance. In one implementation, the virtual-reality rendering appliance is a headset. A wireless receiver in the headset receives the virtual-reality-environment data from the virtual-reality engine associated with the headset and passes the data to an LCD-panel control board, which demultiplexes the audio and video data, forwarding the video data to an LCD panel for display to a participant and forwards the audio data to an audio-playback subsystem, such as headphones. In certain implementations, the virtual-reality rendering appliances may include inertial measuring units that collect and transmit acceleration information back to the virtual-reality engines to facilitate accurate position and orientation determination and projection.

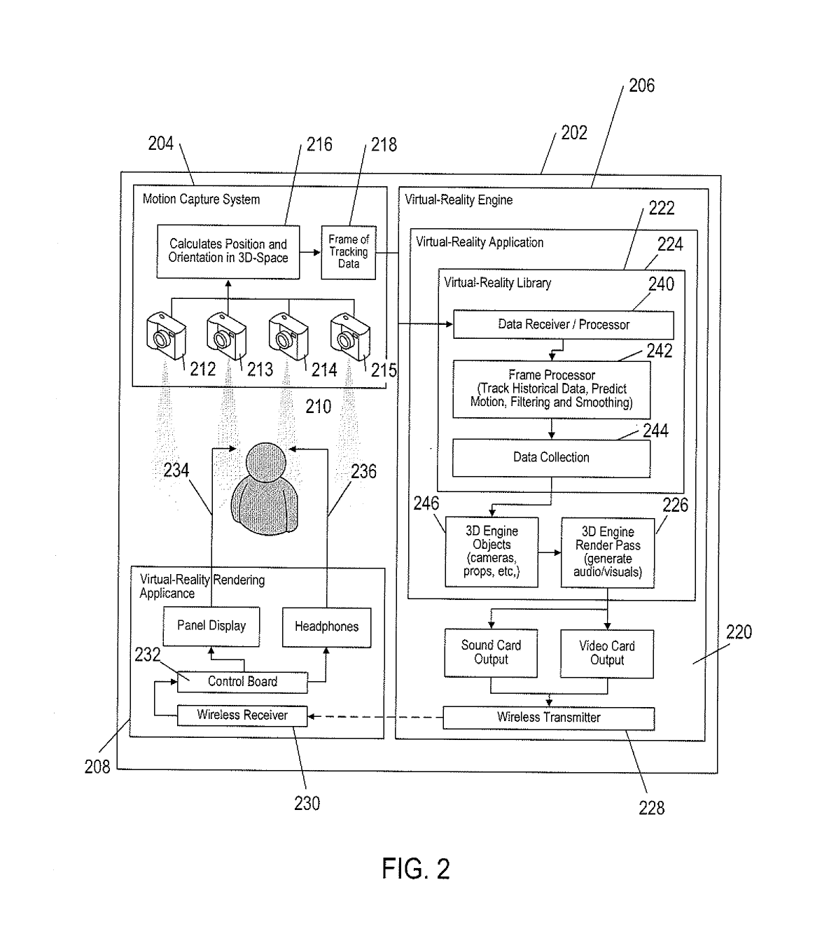

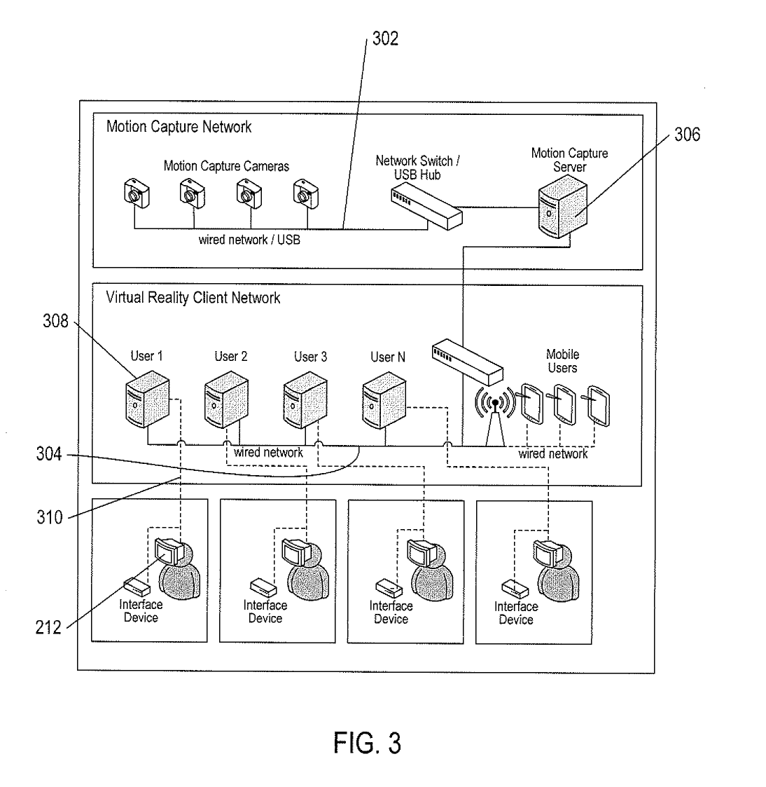

Next, a series of block diagrams are provided to describe details of one virtual-reality-presentation-volume implementation. FIGS. 2-3 illustrate the interconnections and data paths between the high-level components and subsystems of the virtual-reality presentation volume. In FIG. 2, the computational and electronic components of the virtual-reality presentation volume are represented as a large, outer block 202 that includes the motion-capture system 204, one of the virtual-reality engines 206, a virtual-reality rendering appliance 208, and a participant 210 within a virtual-reality presentation volume. The motion-capture system includes multiple optical cameras 212-215 that continuously transmit images to the computational tracking system 216. The computational tracking system generates tracking data from the received images and outputs the tracking data as tracking-data frames 218 to a network that interconnects the virtual-reality engines. The virtual-reality engine 206 includes an underlying processor-controlled computational platform 220 that executes a virtual-reality application 222. The virtual-reality application 222 uses library routines 224 to interpret received tracking data in order to apply position, orientation, velocity, acceleration, and projected-position data to entities within the virtual-reality presentation volume. The virtual-reality application 222 then generates virtual-reality-environment data 226 that is output to a wireless transmitter 228 for broadcast to a wireless receiver 230 within the virtual-reality rendering appliance 208. The virtual-reality rendering appliance employs a control board 232 to demultiplex received data and generate data streams to the stereoscopic visual display 234 and to the audio system 236. The library routines receive tracking data through receiver/processor functionality 240, continuously process received tracking-data frames 242 in order to compile position, orientation, velocity, acceleration, and projected-position information 244 for each of the tracked entities within the virtual-reality environment in order to continuously apply position, orientation, velocity, acceleration, and projected-position information 246 to tracked entities.

FIG. 3 shows the network structure of the virtual-reality presentation volume. The virtual-reality presentation volume includes a motion-capture network 302 and a virtual-engine network 304. The motion-capture network 302 may include a system of network-based motion capture cameras and network switches or USB-based motion-capture cameras and synchronized USB hubs. The images generated by the motion capture cameras are continuously transmitted to the motion-capture server 306. The motion-capture server may be optionally connected to an external network in order to send and receive tracking data with a remote motion-capture network over a virtual private network (“VPN”) or similar communications technology. The motion-capture server 306 is connected to the virtual-engine network 304. Each virtual-reality engine, such as virtual-reality engine 308, may request a motion-capture-data stream from the motion-capture server 306. The virtual-engine network comprises multiple user-facing computers and mobile devices that serve as the underlying computational platforms for the virtual-reality engines, which may include virtual-reality-capable phones, tablets, laptops, desktops, and other such computing platforms. A virtual-reality-engine network infrastructure may include a network switch or other similar device as well as a wireless access point. The network switch may be connected to a network that provides access to external networks, including the Internet. The virtual-reality engines may intercommunicate over the virtual-reality-engine network in order to exchange information needed for multi-participant virtual-reality environments. Each virtual-reality engine, such as virtual-reality engine 308, communicates by wireless communications 310 to a virtual-reality rendering appliance 312 associated with the virtual-reality engine.

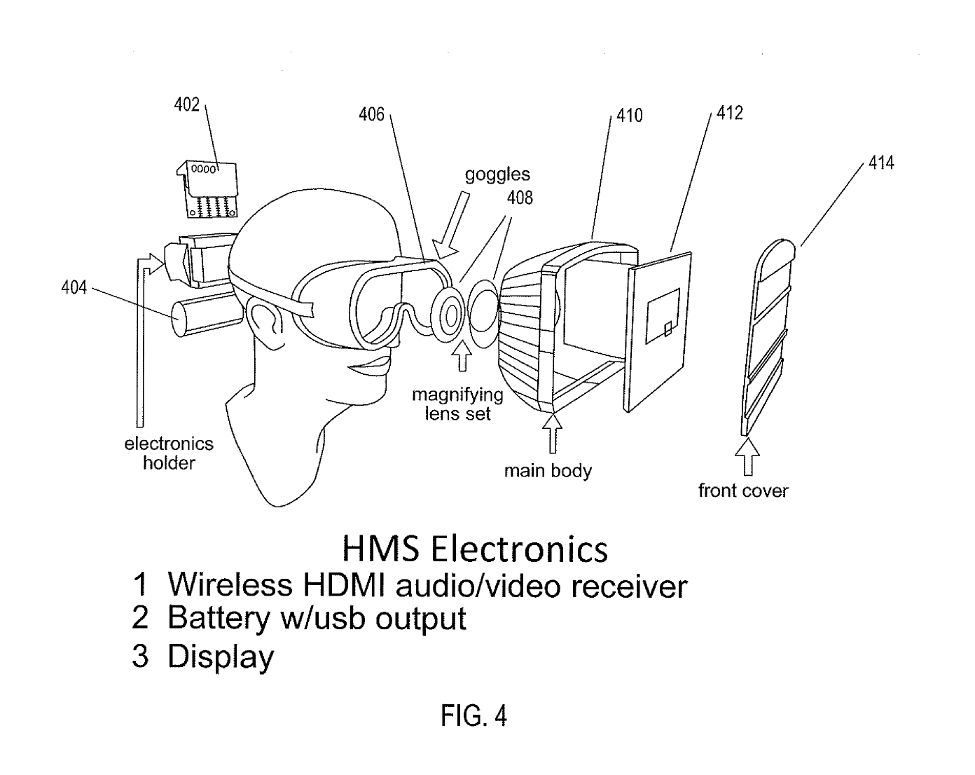

FIG. 4 shows an exploded view of a headset that represents one implementation of a virtual-reality rendering appliance. The headset includes a wireless HDMI audio/video receiver 402, a battery with USB output 404, goggles 406, a set of magnifying lenses 408, a headset body 410, a display and controller logic 412, and a front cover 414.

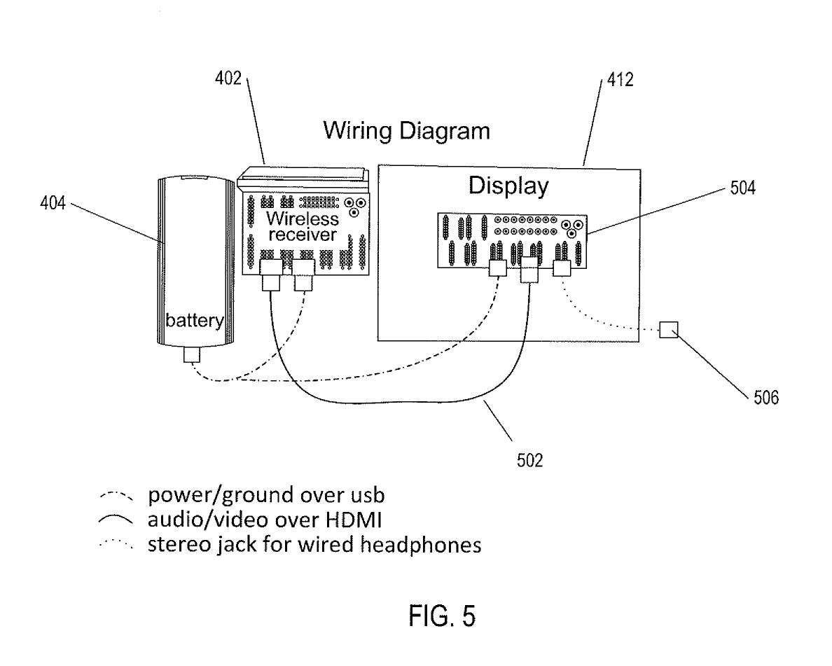

FIG. 5 provides a wiring diagram for the headset implementation of the virtual-reality rendering appliance illustrated in FIG. 4. Power to the wireless receiver 402 and the display/control logic 412 is provided by battery 404. Cable 502 provides for transmission of audio/video signals over HDMI from the wireless receiver 402 to the display controller 504. Audio signals are output to a stereo jack 506 to which wired headphones are connected.

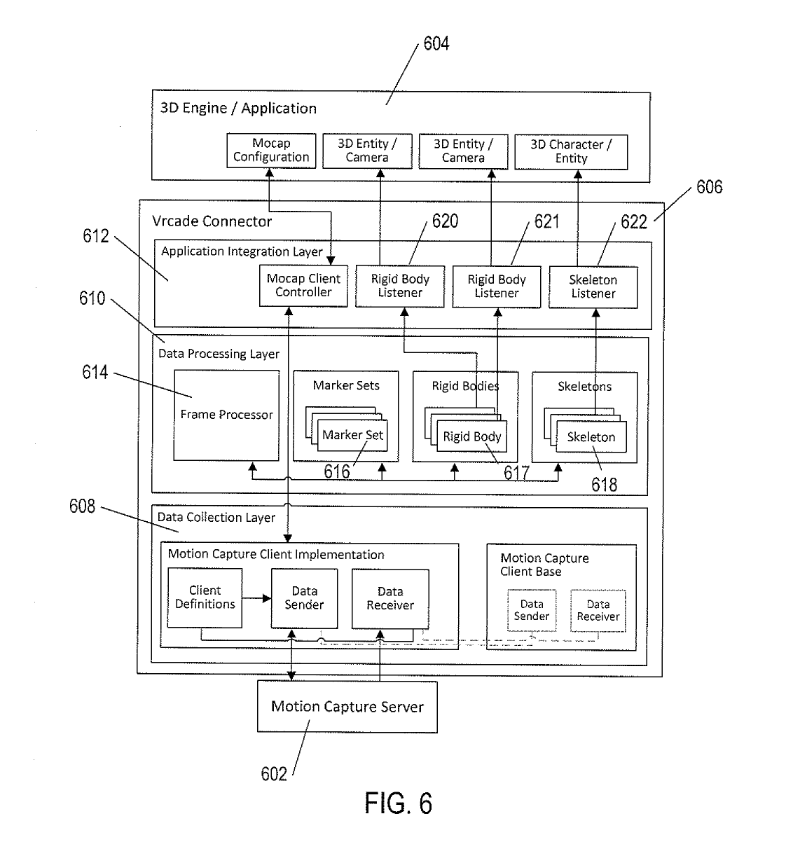

FIG. 6 uses a block-diagram representation to illustrate the virtual-reality library that continuously receives tracking data from the motion-capture server and applies position and orientation information to virtual components of the virtual-reality environment generated by the virtual reality application within a virtual-reality engine. In FIG. 6, the motion-capture server is represented by block 602 and the virtual-reality application is represented by block 604. The virtual-reality library is represented by block 606. The virtual-reality library includes three main layers: (1) a data-collection layer 608; (2) a data-processing layer 610; and (3) an application-integration layer 612.

The data-collection layer 608 includes a base class for creating and depacketizing/processing incoming tracking-data frames transmitted to the virtual-reality engine by a motion-capture server. The base class contains the methods: Connect, Disconnect, ReceivePacket, SendPacket, and Reconnect. The data-collection layer is implemented to support a particular type of motion-capture server and tracking-data packet format. The Connect method receives configuration data and creates a UTD connection to receive data and a transmission control protocol (“TCP”) connection to send commands to the motion-capture server. Sending and receiving of data is asynchronous. The Disconnect method closes communications connections, deallocates resources allocated for communications, and carries out other such communications-related tasks. The Reconnect method invokes the Disconnect and Connect methods in order to reestablish communications with the motion-capture server. The ReceivePacket method asynchronously executes to continuously receive tracking data from the motion-capture server. The ReceivePacket method depacketizes tracking-data frames based on data-frame formatting specifications provided by the manufacturer or vendor of the motion-capture implementation executing within the motion-capture server. The depacketized data is collected into generic containers that are sent to the frame-processing layer 610. The SendPacket method executes asynchronously in order to issue commands and transmit configuration data to the motion-capture server.

The data-processing layer 610 stores and manages both historical tracking data and the current tracking data continuously received from the motion-capture server via the data-collection layer. The data-processing layer includes a frame processor 614 that is responsible for receiving incoming tracking data, placing the tracking data in appropriate data structures, and then performing various operations on the data-structure-resident tracking data in order to filter, smooth, and trajectorize the data. Computed trajectories are used for predictive motion calculations that enable the virtual-reality application to, at least in part, mitigate latency issues with respect to motion capture and provision of position and orientation information to the virtual-reality application. The term “marker” is used to refer to the (x,y,z) coordinates of a tracking marker. A marker set is a set of markers. In certain cases, a set of markers may be used to define the position and orientation of a rigid body. A rigid body is represented as a collection of markers which together are used to define an (x,y,z) position for the rigid body as well as an orientation defined by either roll, pitch, and yaw angles or a quaternion. Multiple hierarchically organized rigid bodies are used to represent a skeleton, or the structure of a human body. The virtual-reality library maintains data structures for markers, marker sets, rigid bodies, and skeletons. These data sets are shown as items 616-618 in FIG. 6. The frame processor 614 demultiplexes tracking data and stores positional and orientation data into these data structures. Historical data is stored for rigid bodies. This historical data is used to filter incoming data for rigid bodies using a simple low-pass filter, defined by: y(n)=x(n−1)+a*x(n)−x(n−1)), where y is the resulting value, x(n) is the current data value, x(n−1) is the previous data value, and a is a defined alpha value between 0 and 1. This filtering is applied both to position and Euler-angle orientation of the rigid value. The filtered data is used to trajectorize motion. Trajectorization involves finding the current, instantaneous velocity and acceleration of the (x,y,z) position and the angular velocity and angular acceleration in terms of the Euler angles. When the data-processing layer updates the data contained in the marker, marker set, rigid body, and skeleton data structures, the data-processing layer makes callbacks to corresponding listeners 620-622 in the application-integration layer 612.

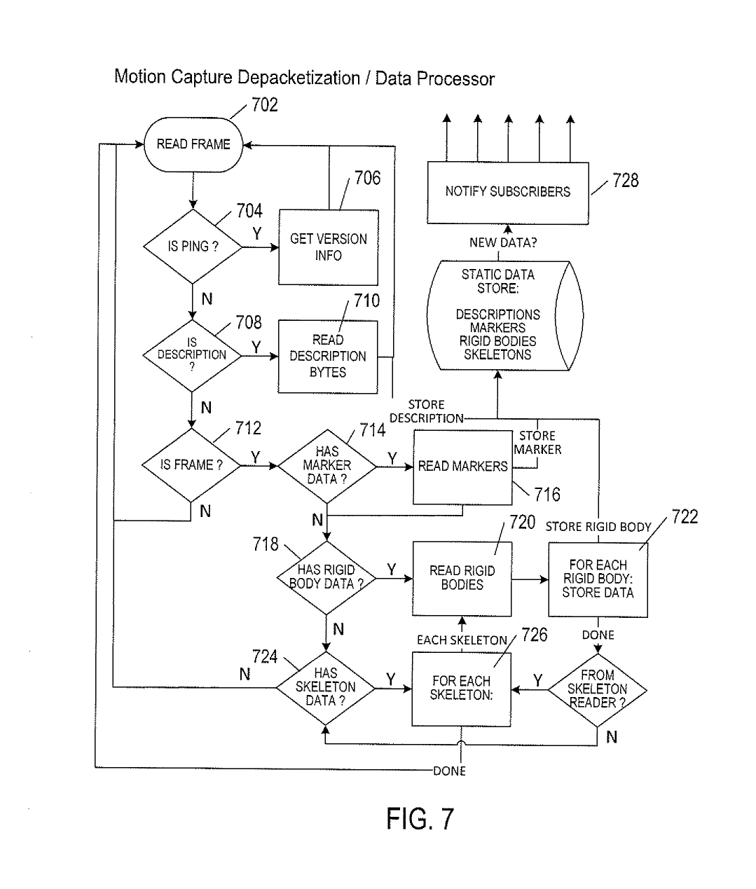

FIG. 7 provides a control-flow diagram that describes tracking-data-frame processing by the data-collection and data-processing layers of the virtual-reality library. For each incoming tracking-data frame, the frame is accessed and read in step 702. When the frame is a ping frame, as determined in step 704, version information is read from the frame, in step 706, and stored. When the frame is a description frame, as determined in step 708, description data is read from the frame, in step 710, and stored. When the frame is a data frame, as determined in step 712, then when the frame includes marker data, as determined in step 714, the marker data is read from the frame in step 716 and the marker data is stored in a marker data structure. When the data frame has rigid-body data, as determined in step 718, then the rigid-body data is read from the frame in step 720 and rigid-body data for each rigid body is stored in appropriate data structures in step 722. When the data frame has skeleton data, as determined in step 724, then for each skeleton which is included in the data frame, represented by step 726, and for each rigid body component of the skeleton, represented by step 720, the data is stored in the appropriate rigid-body data structure in step 722. When new data is stored, appropriate listeners are notified in step 728.

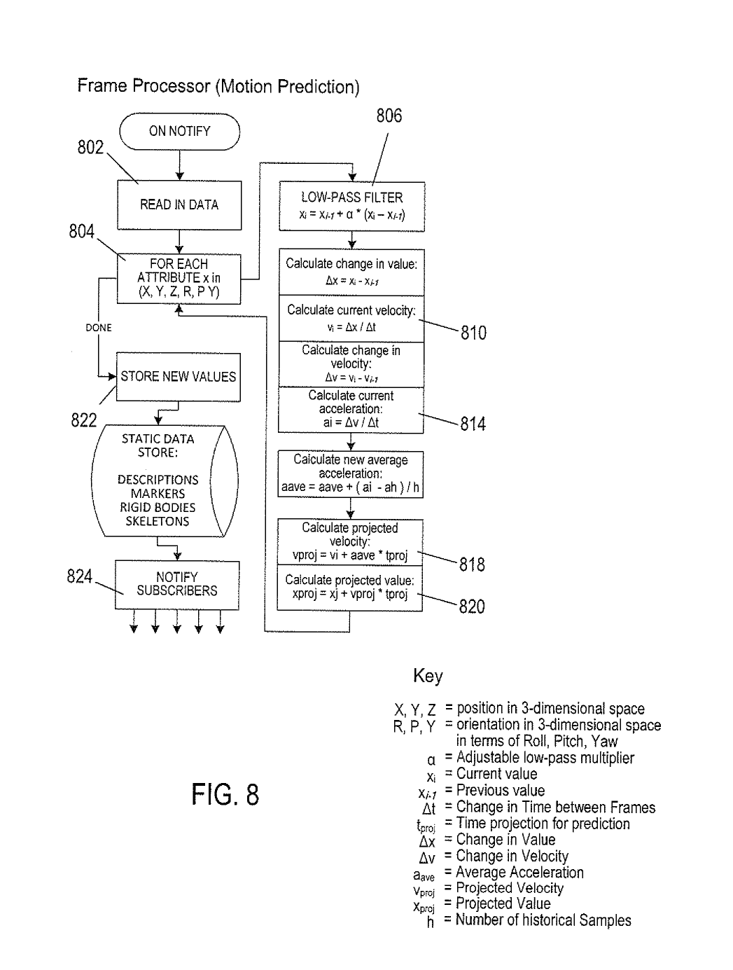

FIG. 8 provides a control-flow diagram for motion prediction by the frame processor (614 in FIG. 6). In step 802, data is read in from the data-collection layer. Then, for each of the position and orientation coordinates and angles, as represented by step 804, the data is low-pass filtered, in step 806, and the current velocity and acceleration are computed in steps 810 and 814. A projected velocity and projected coordinate value are computed in steps 818 and 820, representing the trajectory information that can be used by the virtual-reality application to mitigate latency. The new computed velocities, accelerations, and projected velocities and coordinate values are stored, in step 822. When new data is stored in any of the data structures, appropriate listeners are notified in step 824.

The application-integration layer (612 in FIG. 6) of the virtual-reality library allows the data-processing layer (610 in FIG. 6) to communicate with the virtual-reality application. The application-integration layer provides generic interfaces for registration with the data-processing layer by the virtual-reality application and for callbacks by the data-processing layer as notification to the virtual-reality application of new incoming data. Application-integration layers generally include a local cached copy of the data to ensure thread safety for virtual-reality-application execution. Cached data values can be used and applied at any point during virtual-reality-environment generation, often during the update loop of a frame call. Frame calls generally occur at 60 times per second or at greater frequencies. The position and orientation data provided by the data-processing layer is integrated both into visual data for the virtual-reality environment as well as for internal computations made by the virtual-reality application. As discussed above, the application-integration layer includes rigid-body and skeleton listeners (620-622 in FIG. 6) which register for receiving continuous updates to position and orientation information and which store local representations of rigid-body data structures in application memory.

As discussed above, low latency provision of position and orientation information by the motion-tracking system to the virtual-reality engines as well as the computational efficiency and bandwidth of the virtual-reality engines combine to produce a convincing virtual-reality environment to participants in the virtual-reality presentation volume. Rendering virtual-reality-environment data for stereoscopic display involves creating two simulation cameras horizontally separated by a distance of approximately 64 millimeters to serve as a left-eye camera and a right-eye camera. The camera positions and orientations are adjusted and pivoted according to tracking data for a participant's head. Prior to rendering a next frame, the two cameras are adjusted and pivoted one final time based on the most current tracking data. A next frame is rendered by storing generated left-eye camera pixels in a left portion of a frame buffer and the right-eye camera pixels in a right portion of the frame buffer. The image data in the frame is then processed by a post-processing shader in order to compensate for optical warping attendant with the optical display system within the virtual-reality rendering appliance. Following compensation for optical warping, images are scaled appropriately to the desired scaling within the virtual-reality environment. A warping coefficient is next computed and applied.

Although the present invention has been described in terms of particular embodiments, it is not intended that the invention be limited to these embodiments. Modifications within the spirit of the invention will be apparent to those skilled in the art. For example, any of many different implementation and design parameters may be varied in order to produce a large number of different possible implementations of the virtual-reality presentation volume. These parameters may include choice of programming language, operating system, underlying hardware components, modular organization, data structures, control structures, and many other such design and implementation parameters. Many third-party products may be incorporated into a given virtual-reality presentation-volume implementation, including virtual-reality games that run as, or in association with, the virtual-reality application within a virtual-reality engine, motion-tracking and prediction components that execute within the motion-capture server, as well as many other components and subsystems within the virtual-reality presentation volume. As discussed above, the data streams multiplexed together and transmitted to the virtual-reality rendering appliance or appliances associated with each participant may include visual and audio data, but may also include a variety of other types of one-way and two-way communication as well as other types of data rendered for input to other biological sensors, including olfactory sensors, pressure and impact sensors, tactile sensors, and other biological sensors. As discussed above, the virtual-reality presentation volume may be applied to a variety of different simulation and entertainment domains, from training and teaching domains to visual review of architectural plans as completed virtual rooms and buildings, virtual-reality games, and many other applications.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A virtual-reality presentation volume comprising:
a scalable, physical volume in which participants can free move and assume arbitrary orientations;
a motion-capture system that continuously determines the positions of markers and the orientations of multi-marker patterns attached to participants and objects in the scalable, physical volume;
a network of virtual-reality engines that receive position and orientation data from the motion-capture system, compute position, orientation, velocity, acceleration, and projected position information for virtual-reality-environment participants and objects, and transfer the position, orientation, velocity, acceleration, and projected position information to virtual-reality applications executing within the virtual-reality engines; and
virtual-reality rendering appliances that receive, by wireless communication, virtual-reality-environment data generated by the virtual-reality applications executing within the virtual-reality engines and that render the received virtual-reality-environment data to provide a virtual-reality environment to participants wearing the virtual-reality rendering appliances.
